(19) United States
(12) Patent Application Publication
(10) Pub. No.: US 2007/0136554 A1
(43) Pub. Date: Jun. 14, 2007

(54) Memory operations in a virtualized system

(76) Inventors: Giora Biran, Zichron-Yaakov (IL); David F. Craddock, New Paltz, NY (US); Thomas Anthony Gregg, Highland, NY (US); Zorik Machusky, Nahariya (IL); Vadim Makhervaks, Austin, TX (US); Renato John Recio, Austin, TX (US); Leah Shalev, Zichron-Yaakov (IL)

Correspondence Address: IBM CORP (YA);C/O YEE & ASSOCIATES PC, P.O. BOX 802333, DALLAS, TX, 75380, US

(21) Appl. No.: 11/301,110

(22) Filed: Dec. 12, 2005

(51) Int. Cl. G06F 12/00; G06F 3/00

(52) U.S. Cl. 711/203; 710/3

(57) ABSTRACT

A computer implemented method, apparatus, and system for sharing an input/output adapter among a plurality of operating system instances on a host server. Virtual memory is allocated and associated with an operating system instance. The virtual memory is translated to one or more real addresses, wherein the one or more real addresses require no further translation. The input/output adapter is exposed to the one or more real addresses. The operating system instance is provided with the one or more real addresses for accessing the virtual memory associated with the operating system instance. Address translation and protection may be performed by the input/output adapter or by the operating system instance.

### BACKGROUND OF THE INVENTION

1. Field of the Invention

The present invention relates generally to communication protocols between a host computer and an input/output (I/O) adapter. More specifically, the present invention provides an implementation for virtualizing memory registration and window resources on a physical I/O adapter. In particular, the present invention provides a mechanism by which a system image, such as a general purpose operating system (e.g. Linux, Unix, or Windows) or a special purpose operating system (e.g. a Network File System server), may directly expose real memory addresses, such as the memory addresses used by a host processor or host memory controller to access memory, to a Peripheral Component Interconnect (PCI) adapter, such as a PCI, PCI-X, or PCI-E adapter, that supports memory registration or windows, such as an InfiniBand Host Channel Adapter, an iwarp Remote Direct Memory Access enabled Network Interface Controller (RNIC), a TCP/IP Offload Engine (TOE), an Ethernet Network Interface Controller (NIC), Fibre Channel (FC) Host Bus Adapters (HBAs), parallel SCSI (pSCSI) HBAs, iSCSI adapters, iSCSI Extensions for RDMA (iSER) adapters, and any other type of adapter that supports a memory mapped I/O interface.

2. Description of the Related Art

Virtualization is the creation of substitutes for real resources. The substitutes have the same functions and external interfaces as their real counterparts, but differ in attributes such as size, performance, and cost. These substitutes are virtual resources and their users are usually unaware of the substitute's existence. Servers have used two basic approaches to virtualize system resources: Partitioning and Hypervisors. Partitioning creates virtual servers as fractions of a physical server's resources, typically in coarse (e.g., physical) allocation units (e.g., a whole processor, along with its associated memory and I/O adapters). Hypervisors are software or firmware components that can virtualize all server resources with fine granularity (e.g., in small fractions of a single physical resource).

Servers that support virtualization presently have two options for handling I/O. The first option is to not allow a single physical I/O adapter to be shared between virtual servers. The second option is to add function into the Hypervisor, or another intermediary, that provides the isolation necessary to permit multiple operating systems to share a single physical adapter.

The first option has several problems. One significant problem is that expensive adapters cannot be shared between virtual servers. If a virtual server only needs to use a fraction of an expensive adapter, an entire adapter would be dedicated to the server. As the number of virtual servers on the physical server increases, this leads to underutilization of the adapters and more importantly to a more expensive solution, because each virtual server would need a physical adapter dedicated to it. For physical servers that support many virtual servers, another significant problem with this option is that it requires many adapter slots, with all the accompanying hardware (e.g., chips, connectors, cables) required to attach those adapters to the physical server.

Although the second option provides a mechanism for sharing adapters between virtual servers, that mechanism must be invoked and executed on every I/O transaction. The invocation and execution of the sharing mechanism by the Hypervisor or other intermediary on every I/O transaction degrades performance. It also leads to a more expensive solution, because the customer must purchase more hardware, either to make up for the cycles used to perform the sharing mechanism or, if the sharing mechanism is offloaded to an intermediary, for the intermediary hardware.

Therefore, it would be advantageous to have mechanism that allows a system image within a multiple system image virtual server to directly expose a portion or all of its associated system memory to a shared PCI adapter without having to go through a trusted component, such as a Hypervisor, without any additional address translation and protection hardware on the host. It would also be advantageous for the system image to expose memory to a shared adapter during an infrequently used operation, such as the assignment of memory to the System Image by the Hypervisor, or when the System Image pin its memory with help from the Hypervisor. It would also be. advantageous to have the mechanism apply to Ethernet Network Interface Controllers (NICs), Fibre Channel (FC) Host Bus Adapters (HBAs), parallel SCSI (pSCSI) HBAs, InfiniBand Host Channel Adapters (HCAs), TCP/IP Offload Engines, Remote Direct Memory Access (RDMA) enabled NICs, iSCSI adapters, iSCSI Extensions for RDMA (iSER) adapters, and any other type of adapter that supports a memory mapped I/O interface.

### SUMMARY OF THE INVENTION

The present invention provides a method, system, and computer program product for allowing a system image within a multiple system image virtual server to directly expose a portion, or all, of its associated system memory to a shared PCI adapter without having to go through a trusted component, such as a Hypervisor, and without any address translation and protection hardware on the host. Specifically, the present invention is directed to a mechanism for sharing conventional PCI I/O adapters, PCI-X I/O Adapters, PCI-Express I/O Adapters, and, in general, any I/O adapter that uses a memory mapped I/O interface for communications.

A mechanism is provided that allows hosts that provide address translation and protection hardware to use that hardware in conjunction with an address translation and protection table in the adapter. A mechanism is also provided that allows a host that does not provide an address translation and protection table to protect its addresses strictly by using an address translation and protection table and a range table in the adapter.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a distributed computer system illustrated in accordance with an illustrative embodiment of the present invention;

FIG. 2 is a functional block diagram of a small host processor node in accordance with an illustrative embodiment of the present invention;

FIG. 3 is a functional block diagram of a small, integrated host processor node in accordance with an illustrative embodiment of the present invention;

FIG. 4 is a functional block diagram of a large host processor node in accordance with an illustrative embodiment of the present invention;

FIG. 5 is a diagram illustrating the key elements of the parallel Peripheral Computer Interface (PCI) bus protocol in accordance with an illustrative embodiment of the present;

FIG. 6 is a diagram illustrating the key elements of the serial PCI bus protocol (PCI-Express, a.k.a. PCI-E) in accordance with an illustrative embodiment of the present;

FIG. 7 is a diagram illustrating the creation of the three access control levels used to manage a PCI family adapter that supports I/O virtualization in accordance with an illustrative embodiment of the present invention;

FIG. 8 is a diagram illustrating the control fields used in the PCI bus transaction to identify a virtual adapter or system image in accordance with an illustrative embodiment of the present invention;

FIG. 9 is a diagram illustrating a virtual adapter management approach for virtualizing adapter in accordance with an illustrative embodiment of the present invention;

FIG. 10 is a diagram illustrating a virtual resource management approach for virtualizing adapter resources in accordance with an illustrative embodiment of the present invention;

FIG. 11 is a diagram illustrating the memory address translation and protection mechanisms used to translate a PCI Bus Address into a Real Memory Address for a PCI Adapter that supports either the Virtual Adapter or Virtual Resource Management approach in accordance with an illustrative embodiment of the present invention;

FIG. 12 is a diagram illustrating the memory address translation and protection tables (ATPT) used by a PCI Adapter that supports either the Virtual Adapter or Virtual Resource Management approach in accordance with an illustrative embodiment of the present invention;

FIG. 13 is a flowchart outlining the functions performed at run-time on the host side by an LPAR manager to register one or more memory addresses that a System Image wants to expose to a PCI Adapter that supports either the Virtual Adapter or Virtual Resource Management approach in accordance with an illustrative embodiment of the present invention;

FIG. 14 is a flowchart outlining the functions performed at run-time on the host side by the System Image to perform an InfiniBand or iWARP (RDMA enabled NIC) Memory Registration operation to a PCI Adapter that supports either the Virtual Adapter or Virtual Resource Management approach in accordance with an illustrative embodiment of the present invention;

FIG. 15 is a flowchart illustrating a memory unpin operation for previously registered memory in accordance with an illustrative embodiment of the present invention;

FIG. 16 is a diagram illustrating the adapter memory address translation and protection mechanisms used to translate a PCI Bus Address into a Real Memory Address for a PCI Adapter that supports either the Virtual Adapter or Virtual Resource Management approach and does not require any host side address translation and protection tables to provide IO Virtualization in accordance with an illustrative embodiment of the present invention;

FIG. 17 is a diagram illustrating the details of the PCI adapter's memory address translation and protection tables on a PCI adapter that supports either the Virtual Adapter or Virtual Resource Management approach and does not require any host side address translation and protection tables to provide IO Virtualization in accordance with an illustrative embodiment of the present invention;

FIG. 18 is a flowchart outlining the functions performed at System Image boot or reconfiguration time by a LPAR manager to allocate memory range related resources to the System Image on a PCI Adapter that supports either the Virtual Adapter or Virtual Resource Management approach in accordance with an illustrative embodiment of the present invention;

FIG. 19 is a flowchart outlining the functions performed by a LPAR manager, either when a set of memory addresses are associated with a System Image or when a System Image pins a set of memory addresses that it is associated with, to register one or more memory ranges that are associated with a System Image to a PCI Adapter that supports either the Virtual Adapter or Virtual Resource Management approach in accordance with an illustrative embodiment of the present invention;

FIG. 20 is a flowchart outlining the functions performed at run-time on the host side by the LPAR manager to perform an InfiniBand or iWARP (RDMA enabled NIC) unpin and destroy of one or more previously registered memory ranges in accordance with an illustrative embodiment of the present invention; and

FIG. 21 is a flowchart outlining the functions performed at run-time by a PCI Adapter that supports either the Virtual Adapter or Virtual Resource Management approach to validate accesses to system memory in accordance with an illustrative embodiment of the present invention.

FIG. 22 is a flowchart illustrating disassociating an LMB with a system image in accordance with an illustrative embodiment of the present invention;

### DETAILED DESCRIPTION OF THE PREFERRED EMBODIMENT

The present invention applies to any general or special purpose host that uses PCI family I/O adapter to directly attach storage or to attach to a network, where the network consists of endnodes, switches, router and the links interconnecting these components. The network links can be Fibre Channel, Ethernet, InfiniBand, Advanced Switching Interconnect, or a proprietary link that uses proprietary or standard protocols.

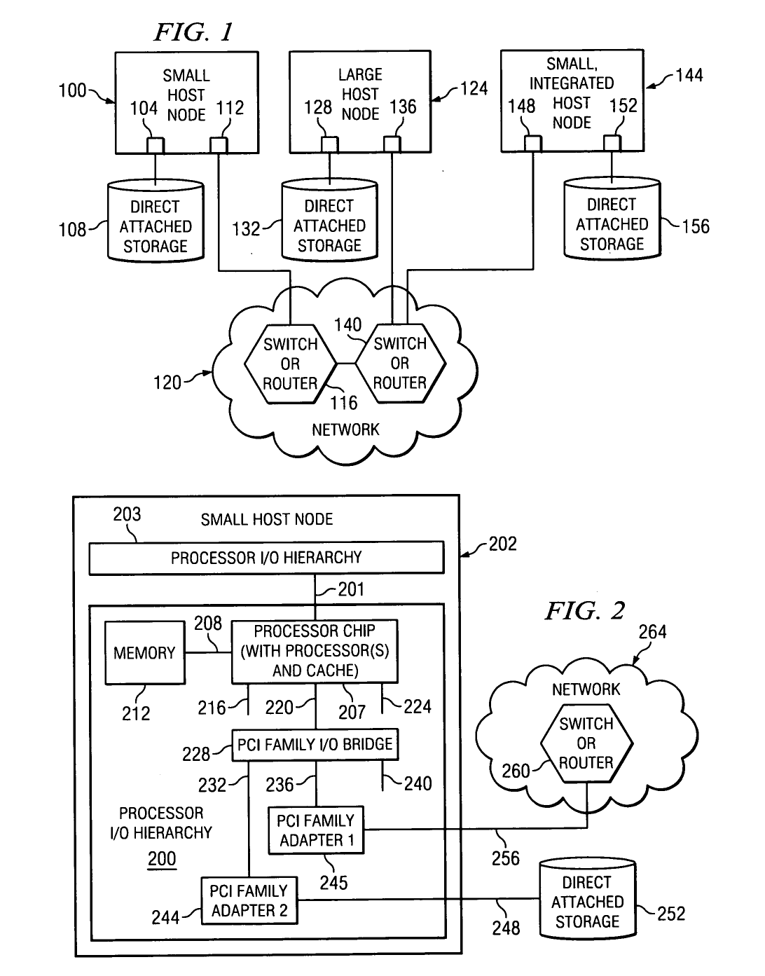

With reference now to the figures and in particular with reference to FIG. 1, a diagram of a distributed computer system is illustrated in accordance with a preferred embodiment of the present invention. The distributed computer system represented in FIG. 1 takes the form of a network, such as network 120, and is provided merely for illustrative purposes and the embodiments of the present invention described below can be implemented on computer systems of numerous other types and configurations. Two switches (or routers) are shown inside of network 120—switch 116 and switch 140. Switch 116 connects to small host node 100 through port 112. Small host node 100 also contains a second type of port 104 which connects to a direct attached storage subsystem, such as direct attached storage 108.

Network 120 can also attach large host node 124 through port 136 which attaches to switch 140. Large host node 124 can also contain a second type of port 128, which connects to a direct attached storage subsystem, such as direct attached storage 132.

Network 120 can also attach a small integrated host node 144 which is connected to network 120 through port 148 which attaches to switch 140. Small integrated host node 144 can also contain a second type of port 152 which connects to a direct attached storage subsystem, such as direct attached storage 156.

Turning next to FIG. 2, a functional block diagram of a small host node is depicted in accordance with a preferred embodiment of the present invention. Small host node 202 is an example of a host processor node, such as small host node 100 shown in FIG. 1.

In this example, small host node 202 includes two processor I/O hierarchies, such as processor I/O hierarchy 200 and 203, which are interconnected through link 201. In the illustrative example of FIG. 2, processor I/O hierarchy 200 includes processor chip 207 which includes one or more processors and their associated caches. Processor chip 207 is connected to memory 212 through link 208. One of links 216, 220, and 224 on the processor chip, such as link 220, connects to PCI family I/O bridge 228. PCI family I/O bridge 228 has one or more PCI family (e.g., PCI, PCI-X, PCI-Express, or any future generation of PCI) links that is used to connect other PCI family I/O bridges or a PCI family I/O adapter, such as PCI family adapter 244 and PCI family adapter 245, through a PCI link, such as link 232, 236, and 240. PCI family adapter 245 can also be used to connect a network, such as network 264, through link 256 via either a switch or router, such as switch or router 260. PCI family adapter 244 can be used to connect direct attached storage, such as direct attached storage 252, through link 248. Processor I/O hierarchy 203 may be configured in a manner similar to that shown and described with reference to processor I/O hierarchy 200.

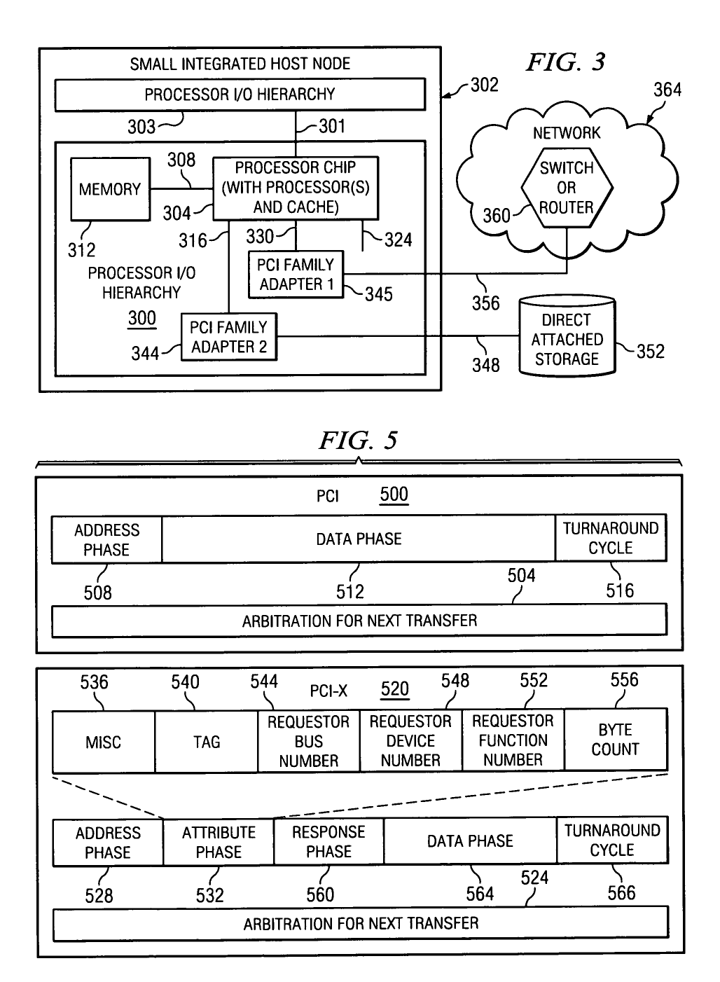

With reference now to FIG. 3, a functional block diagram of a small integrated host node is depicted in accordance with a preferred embodiment of the present invention. Small integrated host node 302 is an example of a host processor node, such as small integrated host node 144 shown in FIG. 1.

In this example, small integrated host node 302 includes two processor I/O hierarchies 300 and 303, which are interconnected through link 301. In the illustrative example, processor I/O hierarchy 300 includes processor chip 304, which is representative of one or more processors and associated caches. Processor chip 304 is connected to memory 312 through link 308. One of the links on the processor chip, such as link 330, connects to a PCI family adapter, such as PCI family adapter 345. Processor chip 304 has one or more PCI family (e.g., PCI, PCI-X, PCI-Express, or any future generation of PCI) links that is used to connect either PCI family I/O bridges or a PCI family I/O adapter, such as PCI family adapter 344 and PCI family adapter 345 through a PCI link, such as link 316, 330, and 324. PCI family adapter 345 can also be used to connect with a network, such as network 364, through link 356 via either a switch or router, such as switch or router 360. PCI family adapter 344 can be used to connect with direct attached storage 352 through link 348.

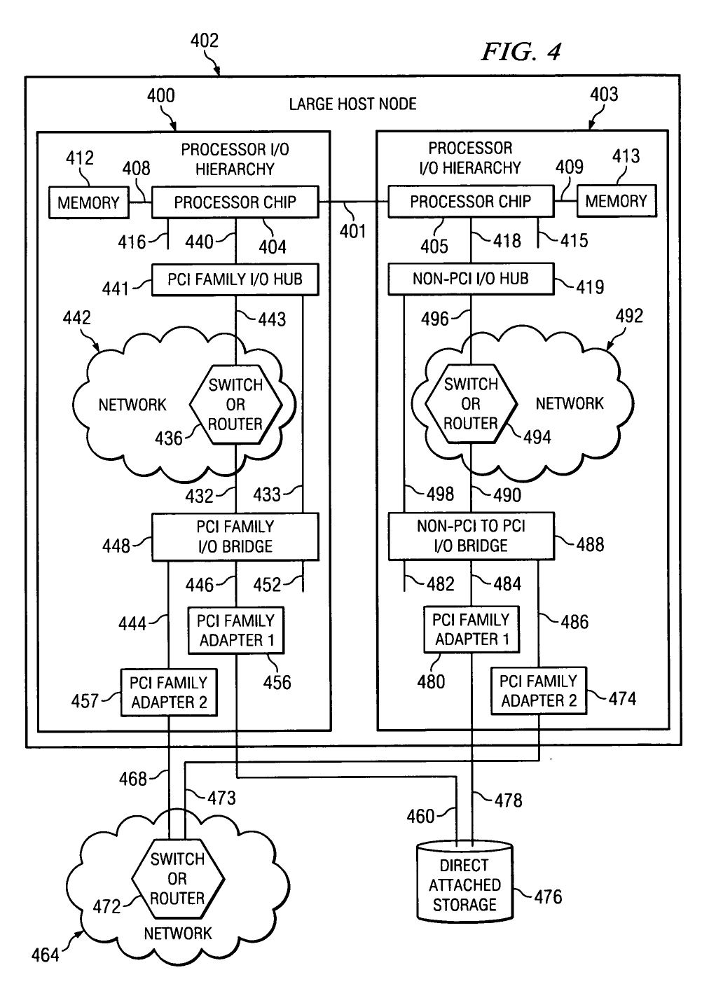

Turning now to FIG. 4, a functional block diagram of a large host node is depicted in accordance with a preferred embodiment of the present invention. Large host node 402 is an example of a host processor node, such as large host node 124 shown in FIG. 1.

In this example, large host node 402 includes two processor I/O hierarchies 400 and 403 interconnected through link 401. In the illustrative example of FIG. 4, processor I/O hierarchy 400 includes processor chip 404, which is representative of one or more processors and associated caches. Processor chip 404 is connected to memory 412 through link 408. One of the links, such as link 440, on the processor chip connects to a PCI family I/O hub, such as PCI family I/O hub 441. The PCI family I/O hub uses a network 442 to attach to a PCI family I/O bridge 448. That is, PCI family I/O bridge 448 is connected to switch or router 436 through link 432 and switch or router 436 also attaches to PCI family I/O hub 441 through link 443. Network 442 allows the PCI family I/O hub and PCI family I/O bridge to be placed in different packages. PCI family I/O bridge 448 has one or more PCI family (e.g., PCI, PCI-X, PCI-Express, or any future generation of PCI) links that is used to connect with other PCI family I/O bridges or a PCI family I/O adapter, such as PCI family adapter 456 and PCI family adapter 457 through a PCI link, such as link 444, 446, and 452. PCI family adapter 456 can be used to connect direct attached storage 476 through link 460. PCI family adapter 457 can also be used to connect with network 464 through link 468 via, for example, either a switch or router 472.

Procesor I/O hierarchy 403 includes processor chip 405, which is representative of one or more processors and associated caches. Processor chip 405 is connected to memory 413 through link 409. One of links 415 and 418, such as link 418, on the processor chip connects to a non-PCI I/O hub, such as non-PCI I/O hub 419. The non-PCI I/O hub uses a network 492 to attach to a non-PCI I/O bridge 488. That is, non-PCI I/O bridge 488 is connected to switch or router 494 through link 490 and switch or router 494 also attaches to non-PCI I/O hub 419 through link 496. Network 492 allows the non-PCI I/O hub and non-PCI I/O bridge to be placed in different packages. Non-PCI I/O bridge 488 has one or more links that are used to connect with other non-PCI I/O bridges or a PCI family I/O adapter, such as PCI family adapter 480 and PCI family adapter 474 through a PCI link, such as link 482, 484, and 486. PCI family adapter 480 can be used to connect direct attached storage 476 through link 478. PCI family adapter 474 can also be used to connect with network 464 through link 473 via, for example, either a switch or router 472.

Turning next to FIG. 5, illustrations of the phases contained in a PCI bus transaction 500 and a PCI-X bus transaction 520 are depicted in accordance with a preferred embodiment of the present invention. PCI bus transaction 500 depicts a conventional PCI bus transaction that forms the unit of information which is transferred through a PCI fabric for conventional PCI. PCI-X bus transaction 520 depicts the PCI-X bus transaction that forms the unit of information which is transferred through a PCI fabric for PCI-X.

PCI bus transaction 500 shows three phases: an address phase 508; a data phase 512; and a turnaround cycle 516. Also depicted is the arbitration for next transfer 504, which can occur simultaneously with the address, data, and turnaround cycle phases. For PCI, the address contained in the address phase is used to route a bus transaction from the adapter to the host and from the host to the adapter.

PCI-X transaction 520 shows five phases: an address phase 528; an attribute phase 532; a response phase 560; a data phase 564; and a turnaround cycle 566. Also depicted is the arbitration for next transfer 524 which can occur simultaneously with the address, attribute, response, data, and turnaround cycle phases. Similar to conventional PCI, PCI-X uses the address contained in the address phase to route a bus transaction from the adapter to the host and from the host to the adapter. However, PCI-X adds the attribute phase 532 which contains three fields that define the bus transaction requestor, namely: requestor bus number 544, requestor device number 548, and requestor function number 552 (collectively referred to herein as a BDF). The bus transaction also contains miscellaneous field 536, tag field 540, and byte count field 556. Tag 540 uniquely identifies the specific bus transaction in relation to other bus transactions that are outstanding between the requestor and a responder. The byte count 556 contains a count of the number of bytes being sent.

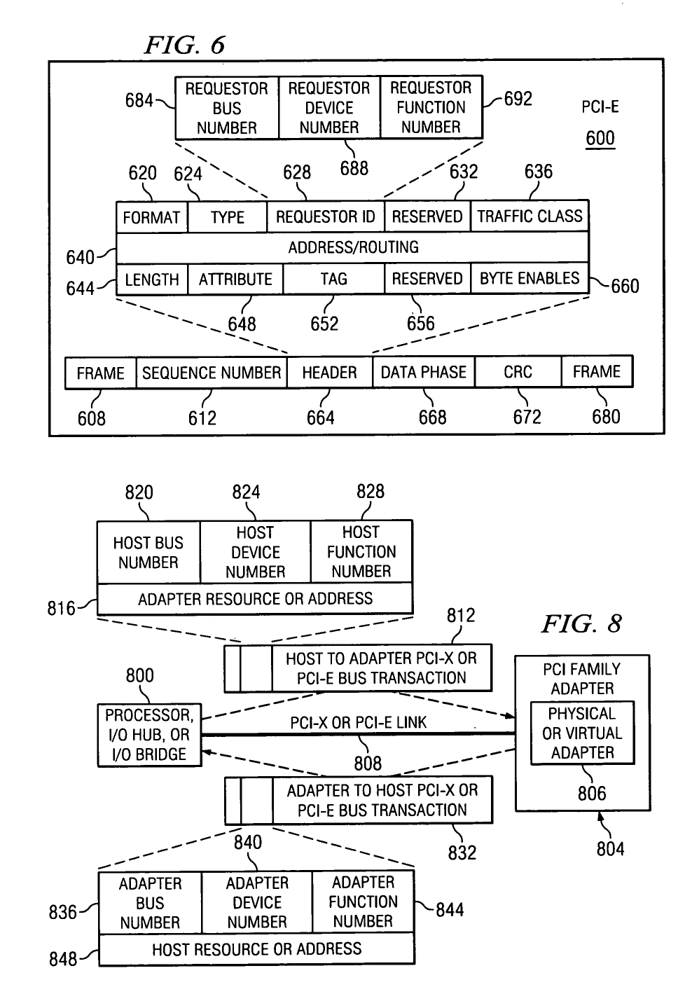

Turning now to FIG. 6, an illustration of the phases contained in a PCI-Express bus transaction is depicted in accordance with a preferred embodiment of the present invention. PCI-E bus transaction 600 forms the unit of information which is transferred through a PCI fabric for PCI-E.

PCI-E bus transaction 600 shows six phases: frame phase 608; sequence number 612; header 664; data phase 668; cyclical redundancy check (CRC) 672; and frame phase 680. PCI-E header 664 contains a set of fields defined in the PCI-Express specification, including format 620, type 624, requestor ID 628, reserved 632, traffic class 636, address/routing 640, length 644, attribute 648, tag 652, reserved 656, byte enables 660. Specifically, the requestor identifier (ID) field 628 contains three fields that define the bus transaction requester, namely: requester bus number 684, requestor device number 688, and requestor function number 692. The PCI-E header also contains tag 652, which uniquely identifies the specific bus transaction in relation to other bus transactions that are outstanding between the requester and a responder. The length field 644 contains a count of the number of bytes being sent.

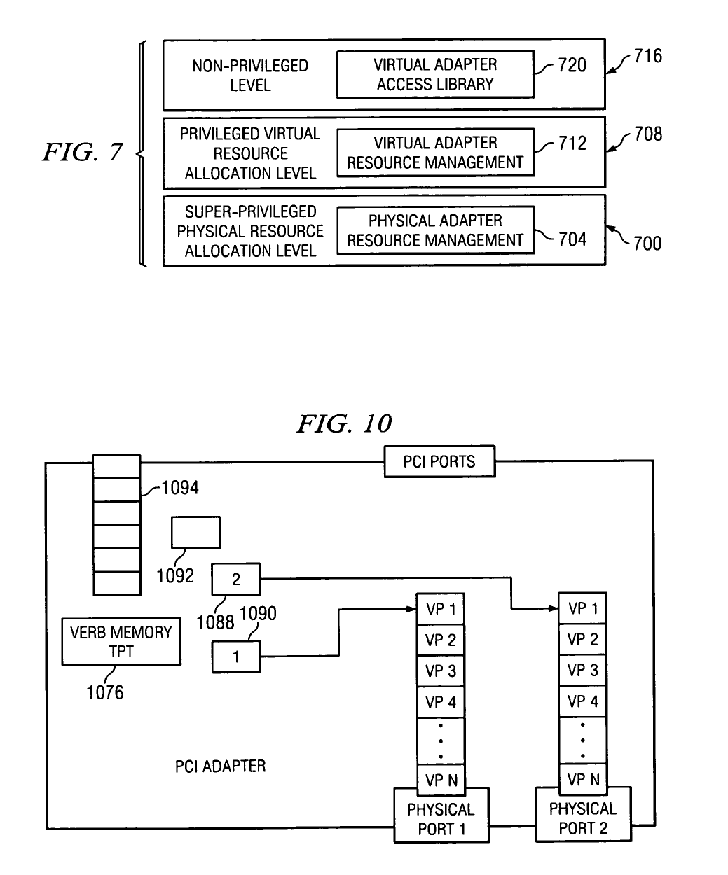

With reference now to FIG. 7, a functional block diagram of the access control levels on a PCI family adapter is depicted in accordance with a preferred embodiment of the present invention. The three levels of access are a super-privileged physical resource allocation level 700, a privileged virtual resource allocation level 708, and a non-privileged level 716.

The functions performed at the super-privileged physical resource allocation level 700 include but are not limited to: PCI family adapter queries, creation, modification and deletion of virtual adapters, submission and retrieval of work, reset and recovery of the physical adapter, and allocation of physical resources to a virtual adapter instance. The PCI family adapter queries are used to determine, for example, the physical adapter type (e.g. Fibre Channel, Ethernet, iSCSI, parallel SCSI), the functions supported on the physical adapter, and the number of virtual adapters supported by the PCI family adapter. The LPAR manager performs the physical adapter resource management 704 functions associated with super-privileged physical resource allocation level 700. However, the LPAR manager may use a system image, for example an I/O hosting partition, to perform the physical adapter resource management 704 functions.

Note that the term system image in this document refers to an instance of an operating system. Typically multiple operating system instances run on a host server and share resources such as memory and I/O adapters.

The functions performed at the privileged virtual resource allocation level 708 include, for example, virtual adapter queries, allocation and initialization of virtual adapter resources, reset and recovery of virtual adapter resources, submission and retrieval of work through virtual adapter resources, and, for virtual adapters that support offload services, allocation and assignment of virtual adapter resources to a middleware process or thread instance. The virtual adapter queries are used to determine: the virtual adapter type (e.g. Fibre Channel, Ethernet, iSCSI, parallel SCSI) and the functions supported on the virtual adapter. A system image performs the privileged virtual adapter resource management 712 functions associated with virtual resource allocation level 708.

Finally, the functions performed at the non-privileged level 716 include, for example, query of virtual adapter resources that have been assigned to software running at the non-privileged level 716 and submission and retrieval of work through virtual adapter resources that have been assigned to software running at the non-privileged level 716. An application performs the virtual adapter access library 720 functions associated with non-privileged level 716.

With reference now to FIG. 8, a depiction of a component, such as a processor, I/O hub, or I/O bridge 800, inside a host node, such as small host node 100, large host node 124, or small, integrated host node 144 shown in FIG. 1, that attaches a PCI family adapter, such as PCI family adapter 804, through a PCI-X or PCI-E link, such as PCI-X or PCI-E Link 808, in accordance with a preferred embodiment of the present invention is shown.

FIG. 8 shows that when a system image performs a PCI-X or PCI-E bus transaction, such as host to adapter PCI-X or PCI-E bus transaction 812, the processor, I/O hub, or I/O bridge 800 that connects to the PCI-X or PCI-E link 808 which issues the host to adapter PCI-X or PCI-E bus transaction 812 fills in the bus number, device number, and function number fields in the PCI-X or PCI-E bus transaction. The processor, I/O hub, or I/O bridge 800 has two options for how to fill in these three fields: it can either use the same bus number, device number, and function number for all software components that use the processor, I/O hub, or I/O bridge 800; or it can use a different bus number, device number, and function number for each software component that uses the processor, I/O hub, or I/O bridge 800. The originator or initiator of the transaction may be a software component, such as a system image, an application running on a system image, or an LPAR manager.

If the processor, I/O hub, or I/O bridge 800 uses the same bus number, device number, and function number for all transaction initiators, then when a software component initiates a PCI-X or PCI-E bus transaction, such as host to adapter PCI-X or PCI-E bus transaction 812, the processor, I/O hub, or I/O bridge 800 places the processor, I/O hub, or I/O bridge's bus number in the PCI-X or PCI-E bus transaction's requestor bus number field 820, such as requestor bus number 544 field of the PCI-X transaction shown in FIG. 5 or requestor bus number 684 field of the PCI-E transaction shown in FIG. 6. Similarly, the processor, I/O hub, or I/O bridge 800 places the processor, I/O hub, or I/O bridge's device number in the PCI-X or PCI-E bus transaction's requestor device number 824 field, such as requester device number 548 field shown in FIG. 5 or requestor device number 688 field shown in FIG. 6. Finally, the processor, I/O hub, or I/O bridge 800 places the processor, I/O hub, or I/O bridge's function number in the PCI-X or PCI-E bus transaction's requestor function number 828 field, such as requester function number 552 field shown in FIG. 5 or requestor function number 692 field shown in FIG. 6. The processor, I/O hub, or I/O bridge 800 also places in the PCI-X or PCI-E bus transaction the physical or virtual adapter memory address to which the transaction is targeted as shown by adapter resource or address 816 field in FIG. 8.

If the processor, I/O hub, or I/O bridge 800 uses a different bus number, device number, and function number for each transaction initiator, then the processor, I/O hub, or I/O bridge 800 assigns a bus number, device number, and function number to the transaction initiator. When a software component initiates a PCI-X or PCI-E bus transaction, such as host to adapter PCI-X or PCI-E bus transaction 812, the processor, I/O hub, or I/O bridge 800 places the software component's bus number in the PCI-X or PCI-E bus transaction's requester bus number 820 field, such as requestor bus number 544 field shown in FIG. 5 or requestor bus number 684 field shown in FIG. 6. Similarly, the processor, I/O hub, or I/O bridge 800 places the software component's device number in the PCI-X or PCI-E bus transaction's requester device number 824 field, such as requestor device number 548 field shown in FIG. 5 or requestor device number 688 field shown in FIG. 6. Finally, the processor, I/O hub, or I/O bridge 800 places the software component's function number in the PCI-X or PCI-E bus transaction's requestor function number 828 field, such as requestor function number 552 field shown in FIG. 5 or requestor function number 692 field shown in FIG. 6. The processor, I/O hub, or I/O bridge 800 also places in the PCI-X or PCI-E bus transaction the physical or virtual adapter memory address to which the transaction is targeted as shown by adapter resource or address field 816 in FIG. 8.

FIG. 8 also shows that when physical or virtual adapter 806 performs PCI-X or PCI-E bus transactions, such as adapter to host PCI-X or PCI-E bus transaction 832, the PCI family adapter, such as PCI physical family adapter 804, that connects to PCI-X or PCI-E link 808 which issues the adapter to host PCI-X or PCI-E bus transaction 832 places the bus number, device number, and function number associated with the physical or virtual adapter that initiated the bus transaction in the requester bus number, device number, and function number 836, 840, and 844 fields. Notably, to support more than one bus or device number, PCI family adapter 804 must support one or more internal busses (For a PCI-X adapter, see the PCI-X Addendum to the PCI Local Bus Specification Revision 1.0 or 1.0a; for a PCI-E adapter see PCI-Express Base Specification Revision 1.0 or 1.0a the details of which are herein incorporated by reference). To perform this function, LPAR manager 708 associates each physical or virtual adapter to a software component running by assigning a bus number, device number, and function number to the physical or virtual adapter. When the physical or virtual adapter initiates an adapter to host PCI-X or PCI-E bus transaction, PCI family adapter 804 places the physical or virtual adapter's bus number in the PCI-X or PCI-E bus transaction's requestor bus number 836 field, such as requester bus number 544 field shown in FIG. 5 or requestor bus number 684 field shown in FIG. 6 (shown in FIG. 8 as adapter bus number 836). Similarly, PCI family adapter 804 places the physical or virtual adapter's device number in the PCI-X or PCI-E bus transaction's requester device number 840 field, such as Requestor device Number 548 field shown in FIG. 5 or requestor device number 688 field shown in FIG. 6 (shown in FIG. 8 as adapter device number 840). PCI family adapter 804 places the physical or virtual adapter's function number in the PCI-X or PCI-E bus transaction's requester function number 844 field, such as requestor function number 552 field shown in FIG. 5 or requester function number 692 field shown in FIG. 6 (shown in FIG. 8 as adapter function number 844). Finally, PCI family adapter 804 also places in the PCI-X or PCI-E bus transaction the memory address of the software component that is associated, and targeted by, the physical or virtual adapter in host resource or address 848 field.

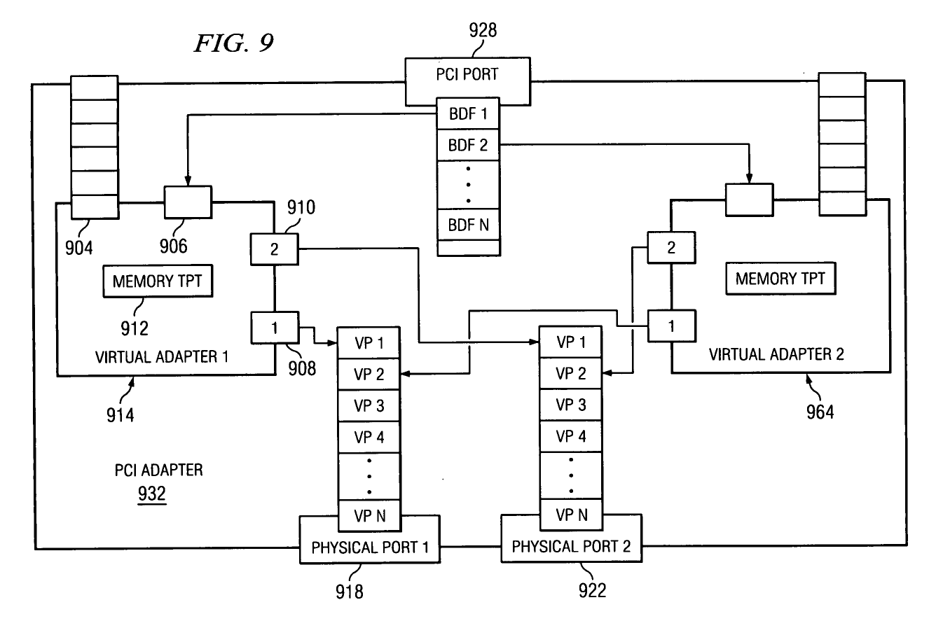

Turning next to FIG. 9, a virtual adapter level management approach is depicted. Under this approach, a physical or virtual host creates one or more virtual adapters, such as virtual adapter 1 914 and virtual adapter 2 964, each containing a set of resources that are within the scope of the physical adapter, such as PCI adapter 932, and a set of resources are associated with the virtual adapter. For example, in virtual adapter 1 914, the set of associated resources may include: processing queues and associated resources, such as 904, a PCI port, such as 928, for each PCI physical port, a PCI virtual port, such as 906, that is associated with one of the possible addresses on the PCI physical port, one or more downstream physical ports, such as 918 and 922, for each downstream physical port, a downstream virtual port that is associated with one of the possible addresses on the physical port, such as 908 and 910, and one or more memory translation and protection tables (TPT), such as 912.

Turning next to FIG. 10, a virtual resource level management approach is depicted. When a resource is created, it is associated with a downstream and possibly an upstream virtual port. In this scenario, there is no concept of a virtual adapter. Under this approach, a physical or virtual host creates one or more virtual resources, such as virtual resource: 1094, which represents a processing queue, 1092, which represents a virtual PCI port, 1088 and 1090, which represent a virtual downstream port, and 1076, which represents a memory translation and protection table.

The present invention allows a system image within a multiple system image virtual server to directly expose a portion, or all, of the system image's system memory to a shared I/O adapter without having to go through a trusted component, such as an LPAR manager or Hypervisor.

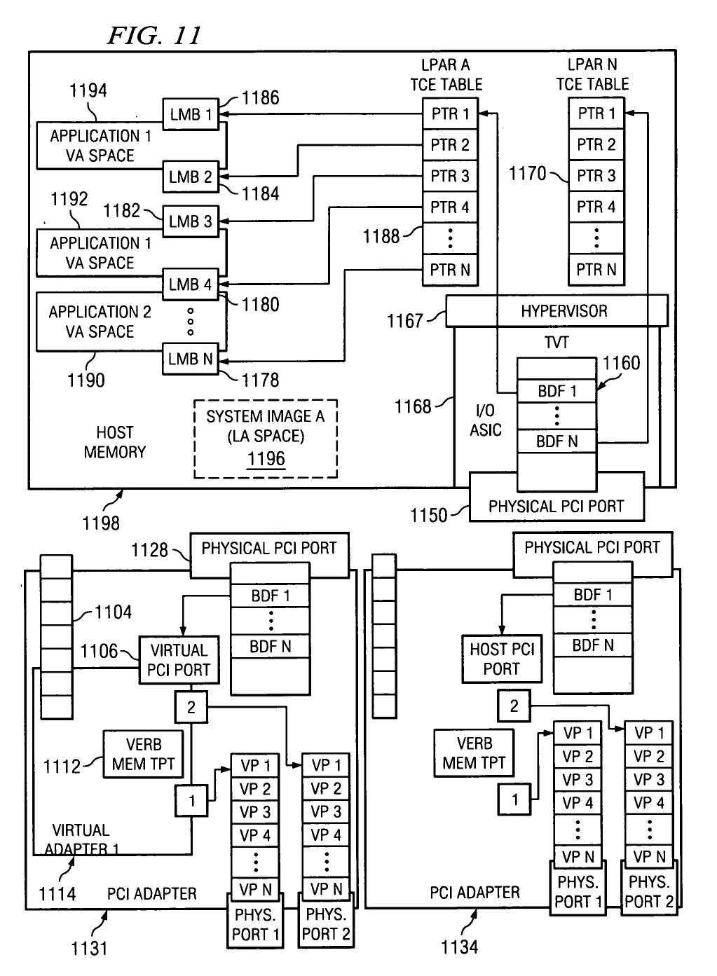

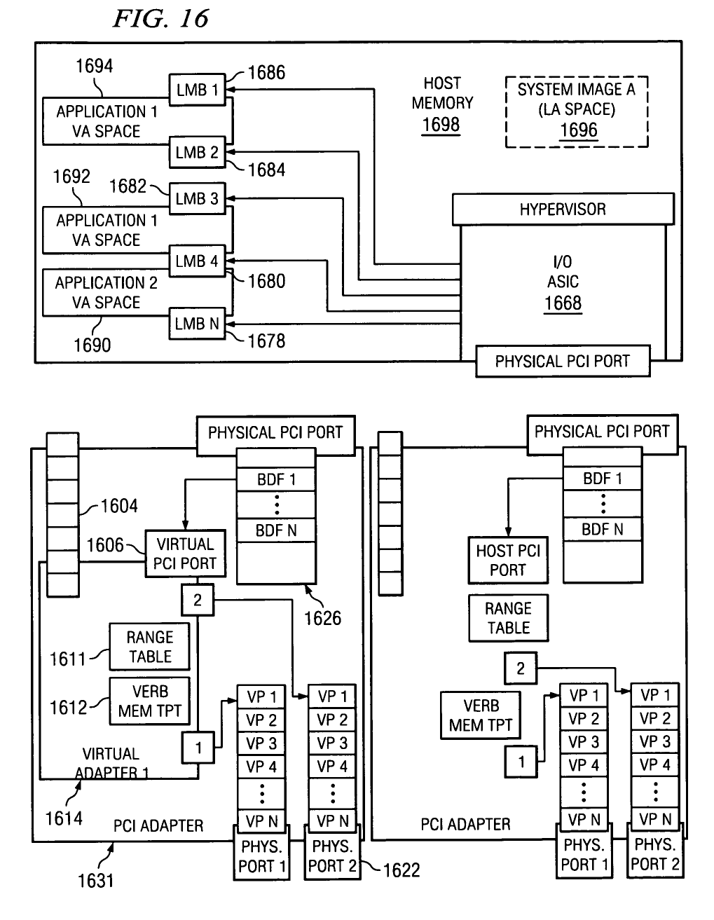

For the purpose of illustration two representative embodiments are described herein. In one representative embodiment, described in FIGS. 11-15, translation and protection tables are located in the system image or host server, and the system image or host server provides address translation and memory protection. In an alternate representative embodiment, described in FIGS. 16-21, the translation and protection tables and range tables are located on the I/O adapter, and the I/O adapter provides address translation and memory protection.

The present invention allows a system image within a multiple system image virtual server to directly expose a portion, or all, of the system image's system memory to a shared I/O adapter without having to go through a trusted component, such as an LPAR manager or Hypervisor.

For the purpose of illustration two representative embodiments are described herein. In one representative embodiment, described in FIGS. 11-15, translation and protection tables are located in the system image or host server, and the system image or host server provides address translation and memory protection. In an alternate representative embodiment, described in FIGS. 16-21, the translation and protection tables and range tables are located on the I/O adapter, and the I/O adapter provides address translation and memory protection.

With reference next to FIG. 11, a diagram illustrating an adapter virtualization approach that allows a system image within a multiple system image virtual server to directly expose a portion or all of its associated system memory to a shared PCI adapter without having to go through a trusted component, such as an LPAR manager, is depicted. Using the mechanisms described in this document, a system image is responsible for registering physical memory addresses it wants to expose to a virtual adapter or virtual resource with the LPAR manager. The LPAR manager is responsible for translating physical memory addresses exposed by a system image into real memory addresses used to access memory and into PCI bus addresses used on the PCI bus. The LPAR manager is responsible for setting up the host ASIC with these translations and access controls and communicating to the system image the PCI bus addresses associated with a system image registration. The system image is responsible for registering virtual or physical memory addresses, along with their PCI bus addresses with the adapter. The host ASIC is responsible for performing access control on memory mapped I/O operations and on incoming DMA and interrupt operations in accordance with a preferred embodiment of the present invention. The host ASIC can use the bus number, device number, and function number from PCI-X or PCI-E to assist in performing DMA and interrupt access control. The adapter is responsible for: associating a resource to one or more PCI virtual ports and to one or more virtual downstream ports; performing the registrations requested by a system image; and performing the I/O transaction requested by a system image in accordance with a preferred embodiment of the present invention.

FIG. 11 depicts a virtual system image, such as system image A 1196, which runs in host memory, such as host memory 1198, and has applications running on it. Each application has its own virtual address space, such App 1 VA Space 1192 and 1194, and App 2 VA Space 1190. The VA Space is mapped by the OS into a set of physically contiguous physical memory addresses. The LPAR manager maps physical memory addresses to real memory addresses and PCI bus addresses. In FIG. 11, Application 1 VA Space 1194 maps into a portion of Logical Memory Block (LMB) 1 1186 and 2 1184. Similarly, Application 1 VA Space 1192 maps into a portion of Logical Memory Block (LMB) 3 1182 and 4 1180. Finally, Application 2 VA Space 1190 maps into a portion of Logical Memory Block (LMB) 4 1180 and N 1178.

A system image, such as System Image A 1196 depicted in FIG. 11, does not directly expose the real memory addresses, such as the addresses used by the I/O ASIC, such as I/O ASIC 1168, to reference Host Memory 1198, to the PCI adapter, such as PCI Adapter 1131 and 1134. Instead, the host depicted in FIG. 11 assigns an address translation and protection table (ATPT) to a system image and to either: a virtual adapter or virtual resource; a set of virtual adapters and virtual resources; or to all virtual adapters and virtual resources. For example, address translation and protection table defined as LPAR A TCE Table 1188, contains the list of host real memory addresses associated with System Image A 1196 and Virtual Adapter 1 1114.

The host depicted in FIG. 11 also contains an Indirect ATPT Index table, where each entry is referenced by the incoming PCI bus, device, function number and contains a pointer to one address translation and protection table. For example, the Indirect ATPT Index table defined as TVT 1160, contains a list of entries, where each entry is referenced by the incoming PCI bus, device, and function number and points to one of the ATPTs, such as TCE table 1188 and 1170. When I/O ASIC 1168 receives an incoming DMA or interrupt operation from a virtual adapter or virtual resource, it uses the PCI bus, device, function number associated with the virtual adapter or virtual resource to look up an entry in the Indirect ATPT Index table, such as TVT 1160. I/O ASIC 1168 then validates that the address or interrupt referenced in the incoming DMA or interrupt operation, respectively, is in the list of addresses or interrupts listed in the ATPT that was pointed to by the Indirect ATPT Index table entry.

For example, in FIG. 11, Virtual Adapter 1131 has a virtual port 1106 that is associated with the bus, device, function number BDF 1 on PCI port 1128. When Virtual Adapter 1131 issues a PCI DMA operation out of PCI port 1128, the PCI operation contains the bus, device, function number BDF 1 which is associated with Virtual Adapter 1131. When PCI port 1150 on I/O ASIC 1168 receives a PCI DMA operation, it uses the operation's bus, device, function number BDF 1 to look up the ATPT associated with that virtual adapter or virtual resource in TVT 1160. In this example, the look up results in a pointer to LPAR A TCE table 1188. The system I/O ASIC 1168 then checks the address within the DMA operation to assure it is an address contained in LPAR A TCE table 1188. If it is, the DMA operation proceeds, otherwise the DMA operation ends in error.

Using the mechanisms depicted in FIG. 11, the host side I/O ASIC, such as I/O ASIC 1168, also isolates Memory Mapped I/O (MMIO) operations to a virtual adapter or virtual resource granularity. The host does this by: having the LPAR manager, or an intermediary such as Hypervisor 1167, associate the PCI bus addresses accessible through system image MMIO operations to the system image associated with the virtual adapter or virtual resource that is accessible through those PCI bus addresses; and then having the host processor or I/O ASIC check that each system image MMIO operation references PCI bus addresses that have been associated with that system image.

FIG. 11 also depicts two PCI adapters: one that uses a Virtual Adapter Level Management approach, such as PCI Adapter 1131; and one that uses a Virtual Resource Level Management approach, such as PCI adapter 1134. PCI Adapter 1131 associates to a host side system image the following: one set of processing queues, such as processing queue 1104; either a verb memory address translation and protection table or one set of verb memory address translation and protection table entries, such as Verb Memory TPT 1112; one downstream virtual port, such as Virtual PCI Port 1106; and one upstream Virtual Adapter (PCI) ID (VAID), such as the bus, device, function number (BDF). If the adapter supports out of user space access, such as would be the case for an InfiniBand Host Channel Adapter or an RDMA enabled NIC, then each data segment referenced in work requests can be validated by checking that the queue pair associated with the work request has the same protection domain as the memory region referenced by the data segment. However, this only validates the data segment, not the Memory Mapped I/O (MMIO) operation used to initiate the work request. The host is responsible for validating the MMIO.

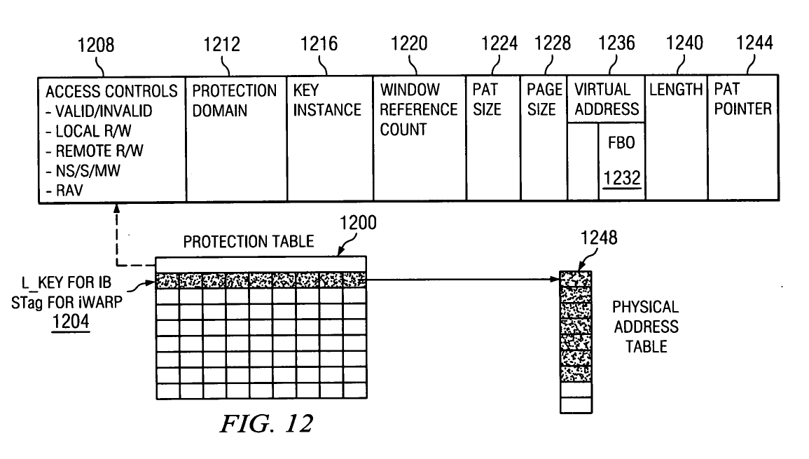

FIG. 12 is a diagram illustrating the memory address translation and protection tables used by a PCI Adapter in accordance with an illustrative embodiment of the present invention. Typically, the PCI adapter can support either the Virtual Adapter or Virtual Resource Management approach. Protection table 1200 in FIG. 12 may be implemented: entirely in the host, in which case the adapter would maintain a set of pointers to the Protection table; entirely in the adapter; or in the host, but with some of the entries cached in the adapter.

A specific record in protection table 1200 is accessed using key 1204, such as a local key (L_KEY) for InifiniBand adapters, or a steering tag (STag) for iWarp adapters. Protection table 1200 comprises at least one record, where each record comprises access controls 1208, protection domain 1212, key instance 1216, window reference count 1220, Physical Address Translation (PAT) size 1224, page size 1228, First Byte Offset (FBO) 1232, virtual address 1236, length 1240, and PAT pointer 1244. PAT pointer 1244 points to physical address table 1248.

Access controls 1208 typically contains access information about a physical address table such as whether the memory referenced by the physical address table is valid or not, whether the memory can be read or written to, and if so whether local or remote access is permitted, and the type of memory, i.e. shared, non-shared or memory window.

Protection domain 1212 associates a memory area with a queue. That is, the context used to maintain the state of the queue, and the address protection table entry used to maintain the state of the memory area, must both have the same protection domain number. Key instance 1216 provides information on the current instance of the key. Window reference count 1220 provides information as to how many windows are currently referencing the memory. PAT size 1224 provides information on the size of physical address table 1248.

Page size 1228 provides information on the size of the memory page. FBO 1232 provides information on the first byte offset into the memory, which is used by iwarp or InfiniBand adapters to reference the first byte of memory that is registered using iwarp or InfiniBand (respectively) Block Mode I/O physical buffer types.

Length 1240 provides information on the length of the memory because a memory area is typically specified using a starting address and a length.

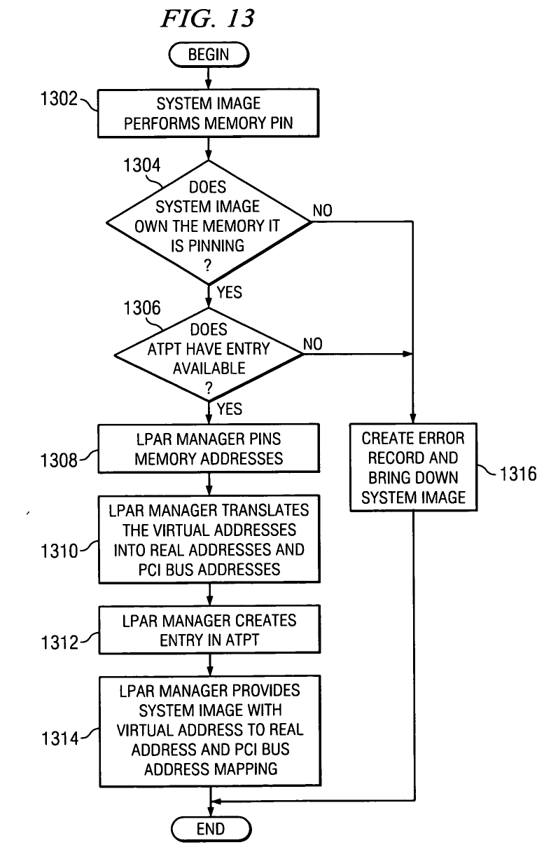

FIG. 13 is a flowchart outlining the functions performed when a System Image performs a memory pin operation in accordance with an illustrative embodiment of the present invention. FIG. 13 outlines the functions typically performed at run-time on the host side by an LPAR manager to register one or more memory addresses that a System Image wants to expose to a PCI Adapter that supports the Virtual Adapter or Virtual Resource Management.

The process depicted in FIG. 13 begins when a System Image performs a Host Memory pin operation in step 1302. The System Image performs a pin operation in order to make the memory non-pageable. Typically a trusted intermediary such as an LPAR manager intercepts or receives the System Image's memory pin request and first determines whether the system image actually owns the memory that the System Image wants to pin in 1304. If the system image does own the memory, then the LPAR manager next determines whether the ATPT has room for an entry in 1306. If the ATPT has room for an entry, the LPAR manager pins the memory addresses supplied by the System Image in 1308.

The LPAR manager next translates the memory addresses, which can be either virtual or physical addresses, into real addresses and PCI bus addresses in 1310, adds an entry in the ATPT in 1312, and provides the System Image with the memory address translation in 1314. That is, for virtual addresses that were supplied by the System Image, it provides the virtual addresses to PCI bus addresses. For physical addresses that were supplied by the System Image, it provides the physical addresses to PCI bus addresses. After step 1314 completes the operation ends.

In the event of an error, such as when the LPAR manager determines that the System Image does not own the memory it wants to pin in 1304 or that the ATPT does not have an entry available in 1306, then the LPAR manager in 1316 creates an error record, brings down the System Image, and the operation ends.

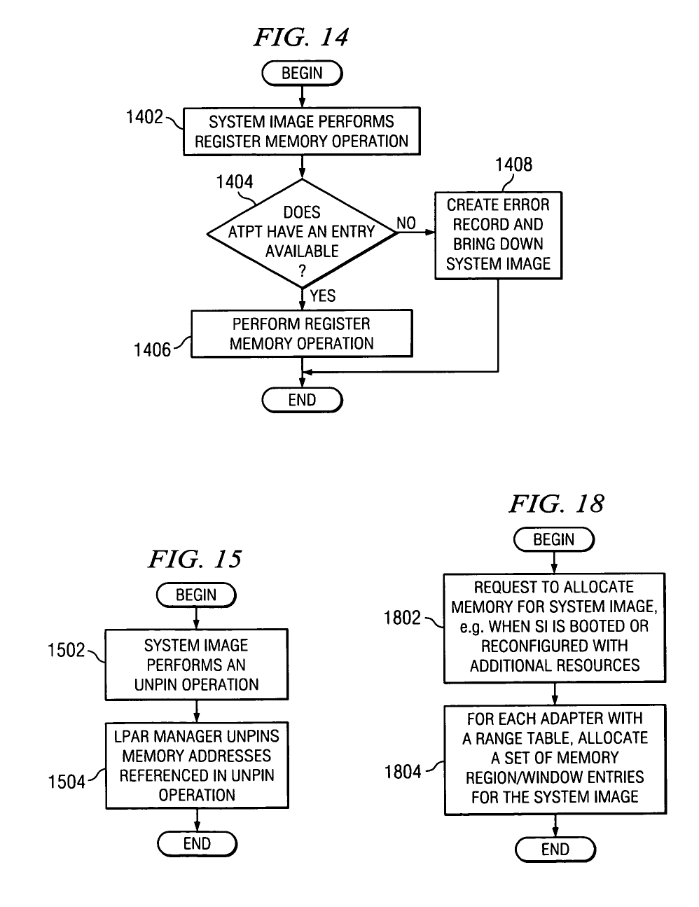

FIG. 14 is a flowchart outlining the functions performed when a system image performs a register memory operation to an I/O Adapter that supports either the Virtual Adapter or Virtual Resource Management approach in accordance with an illustrative embodiment of the present invention. Typically, the memory registration operation is done for an I/O adapter supporting InfiniBand or iWARP (RDMA enabled NIC). The I/O adapter may use the PCI, PCI-E, PCI-X or similar bus.

The operation begins when a system image performs a register memory operation in 1402. In 1404 the adapter checks to see if the adapter's ATPT has an entry available. If an entry is available in the adapter's ATPT, then in 1406 the adapter performs a register memory operation and the operation ends. If an entry in the adapter's ATPT is not available, an error record is created in 1408. The operation then ends.

FIG. 15 is a flowchart illustrating a memory unpin operation for previously registered memory in accordance with an illustrative embodiment of the present invention. FIG. 15 applies to the mechanism disclosed in FIGS. 11-14.

Typically, one or more logical memory blocks (LMB) are associated or disassociated with a system image during a configuration event. A configuration event usually occurs infrequently. In contrast, memory within an LMB is typically pinned or unpinned frequently such that it is common for memory pinning or unpinning to occur millions of times a second on a high end server.

The operation begins when a system image performs an unpin operation in 1502. The LPAR manager unpins the memory addresses referenced in the unpin operation in 1504 and the operation ends.

FIG. 16 is a diagram illustrating the adapter memory address translation and protection mechanisms used to translate a PCI bus address into a real memory address for a PCI adapter that supports either the virtual adapter or virtual resource management approach and does not require any host side address translation and protection tables to provide I/O virtualization, in accordance with an illustrative embodiment of the present invention. The mechanisms of the present invention described in FIG. 16 through FIG. 22 provide a performance enhancement compared to the mechanisms described in FIG. 11 through FIG. 15. The performance enhancements stems from allowing a System Image to perform a memory registration operation without having the operation intercepted or received and handled by an LPAR manager.

Typically, memory pages can be accessed through four types of addresses: Virtual Addresses, Physical Addresses, Real Addresses, and PCI Bus Addresses.

A Virtual Address is the address a user application running in a System Image uses to access memory. Typically, the memory referenced by the Virtual Address is protected so that other user applications cannot access the memory.

A Physical Address refers to the address the system image uses to access memory. A Real Address is the address a system processor or memory controller uses to access memory. A PCI Bus Address is the address an I/O adapter uses to access memory.

Typically, on a system that does not support an LPAR manager (or Hypervisor), when an I/O adapter accesses memory, the System Image translates the Virtual Address to a Physical Address, the Physical Address to a Real Address, and finally the Real Address to a PCI Bus Address.

Typically, on a system that does support an LPAR Manager (or Hypervisor), when an I/O adapter accesses memory, the System Image translates the Virtual Address to a Physical Address, and then the LPAR manager (or Hypervisor) translates the Physical Address to a Real Address and then a PCI Bus Address.

Servers that provide I/O access protection use an I/O address translation and protection mechanism to determine if an I/O adapter is associated with a PCI Bus Address. If the adapter is associated with the PCI Bus Address, then the I/O address translation and protection mechanism is used to translate the PCI Bus Address into a Real Address. Otherwise an error occurs.

The remainder of this discussion, FIGS. 16-21, relates to a mechanism whereby an LPAR manager (or Hypervisor) may set the PCI Bus Addresses equal to the Real Memory Addresses and create a range table with entries containing the set of PCI Bus Addresses which each System Image can access. This allows the LPAR manager (or Hypervisor) to provide a specific System Image with a Real Address which equals the corresponding PCI Bus Address, so that the Real Address needs no further translation. The system image may then directly expose the Real Address to the I/O adapter so that the I/O adapter can use the SI ID (System Image Identifier) and Range Table to validate access to the memory referenced by the corresponding real address.

In FIG. 16, the LPAR manager allocates one or more LMBs for the system image, maps the allocated LMBs to the system image's memory space, and through the mechanism disclosed by the present invention, exposes as PCI bus addresses the real memory addresses associated with the system image to the adapter. In other words, the present invention provides a mechanism for a system image to expose the real addresses to the adapter without the LPAR manager being involved, and for the adapter to ensure that the system image is associated with the real addresses it is attempting to expose or access. If the system image is associated with the real addresses it is attempting to expose, the present invention allows the adapter to directly access system memory by using the real addresses as PCI bus addresses, without having to go through an address translation and protection mechanism.

Except for the range tables, which the system image is prevented from accessing by the LPAR manager (or Hypervisor), the system image may utilize real addresses in all internal adapter structures, such as, for example, protection tables, translation tables, work queues, and work queue elements. In addition, the system image may use real addresses in the page-list provided in Fast Memory Registration operations. The adapter is thus made aware of the LMB structure, as well as the association of the particular LMB with a system image.

Using the system image ID and range table, the adapter may validate whether or not a real address the system image is attempting to expose or access is actually associated with that system image. Thus, the adapter is trusted to perform memory access validations to prevent unauthorized access to the system memory. Having the adapter validate memory access is thus faster and more efficient than having an LPAR manager validate memory access.

The adapter, such as virtual adapter 1614, is responsible for access control when performing I/O operations requested by the system image. The access control may include validating that access to the real address is authorized for the given system image, and validating access is authorized based on the system image ID and information in the range tables. The adapter is also responsible for: associating a resource to one or more PCI virtual ports and to one or more virtual downstream ports; performing the memory registrations requested by a system image; and performing I/O transactions associated with a system image in accordance with illustrative embodiments of the present invention.

Like the adapter virtualization approach described in FIG. 11, a virtual system image, such as system image A 1696, is shown to run in host memory, such as host memory 1698. Each application running on a system image has its own virtual address space, such App 1 VA Space 1692 and 1694, and App 2 VA Space 1690. The VA Space is mapped by the OS into a set of physically contiguous physical memory addresses. For example, application 1 VA Space 1694 maps into a portion of Logical Memory Block (LMB) 1 1686 and 2 1684.

PCI Adapter 1631 associates to a host side system image one set of processing queues, such as processing queue 1604, either a verb memory address translation and protection table or a set of verb memory address translation and protection table entries, such as Verb Memory translation and protection tables (TPT) 1612; one downstream virtual port, such as Virtual PCI Port 1606; and one upstream Virtual Adapter (PCI) ID (VAID), such as the bus, device, function number (BDF 1626). If the adapter supports out of user space access, such as would be the case for an InfiniBand Host Channel Adapter or an RDMA enabled NIC, then the I/O operation used to initiate a work request may be validated by checking that the queue pair associated with the work request has the same protection domain as the memory region referenced by the data segment.

Verb Mem TPT 1612 is a memory translation and protection table that may be implemented in adapters capable of supporting memory registration, such as InfiniBand and iwarp-style adapters. Verb Mem TPT 1612 is used by the adapter to validate access to memory on the host. For example, when the system image wants the adapter to access a memory region of the system image, the system image passes a PCI Bus address to the adapter, the length and a key, such as L_key for an Infiniband adapter and Stag for an iwarp adapter. The key is used to access an entry in Verb Mem TPT 1612.

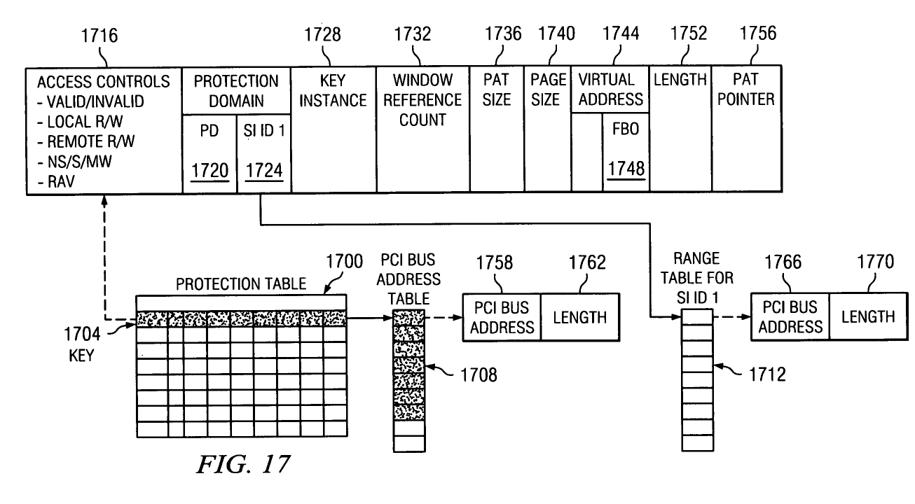

Verb Mem TPT 1612 controls access to memory regions on the host by using a set of variables, such as, for example, local read, local write, remote read, remote write. Verb Mem TPT 1612 also comprises a protection domain field, which is used to associate an entry in the table with a queue. As will be described further in FIG. 17, this association is used by the adapter to determine the set of queues that can use the entry in the Verb Mem TPT 1612, for all queues that use a Verb Mem TPT 1612 entry must all have the same protection domain. A system image ID pointer is also included in Verb Mem TPT 1612. The system image ID pointer is used to point to the range table entry corresponding to a particular system image, such as sys image ID A 1696. In this way the SI ID pointer is used to associate a Verb Mem TPT 1612 entry to the set of Logical Memory Blocks associated with the System Image.

In this illustrative embodiment, virtual adapter 1614 is also shown to contain range table 1611. Range table 1611 is used to determine the LMB addresses that system image 1696 may use. For instance, as shown in FIG. 16, if sys image A 1696 is described in range table 1611, the range table may include references to LMB 1 1686 to LMB N 1678, wherein the entry for LMB 1=PCI bus address 1+length of LMB 1, LMB 2=PCI bus address 2+length of LMB 2, etc. Range table 1611 may be implemented in various ways, including, for example: using CAM that checks to see if the PCI Bus Address generated from the .Verb Mem TPT 1612 entry is within one of the ranges, consisting of the PCI Bus address +length, in the Range table; using a a processor and code to perform the same check; and using a hash table, which function is based on real addresses or part of it as an input to the hash function. The Range Table 1611 used by each one of the CAM, processor and code algorithm, and hash approaches may be located in the internal adapter memory, in host memory, or cached in the internal adapter memory.

The LPAR manager, or an intermediary, sets the PCI Bus Addresses equal to the Real Addresses and provides the PCI Bus addresses to the system image associated with the allocated LMBs. The LPAR manager is responsible for updating the internal adapter's Logical Memory Block structure, or range table 1611, and the System Image ID field in the Verb Mem TPT 1612 which together used for memory access validation. The system image is responsible for updating all other internal adapter structures.

FIG. 17 is a diagram illustrating a memory address translation and protection table for an I/O adapter in accordance with an illustrative embodiment of the present invention. Typically, the I/O adapter supports either the Virtual Adapter or Virtual Resource Management approach and does not require any host side address translation and protection tables to provide I/O Virtualization. Protection table 1700 in FIG. 17 may be implemented as Verb Mem TPT 1612 in FIG. 16.

A specific record in protection table 1700 is accessed using key 1704, such as a local key (L_KEY) for Infiniband adapters, or a steering tag (STag) for iwarp adapters. Protection table 1700 comprises one or more records, where each record comprises access controls 1716, protection domain 1720, system image identifier (SI ID 1) 1724, key instance 1728, window reference count 1732, PAT size 1736, page size 1740, virtual address 1744, FBO 1748, length 1752, and PAT pointer 1756. All fields in a Protection Table record, such as protection table 1700, can be written and read by the System Image, except the System Image Identifier field, such as SI ID 1 1724. The System Image Identifier field, such as SI ID 1 1724, can only be read or written by the LPAR manager or by the PCI Adapter.

PAT pointer 1756 points to physical address table 1708, which in this example is a PCI bus address table. SI ID 1 1724 points to Logical Memory Block (LMB) table, or range table, 1712 that is associated with a specific system image.

Access controls 1716 typically contains access information about a physical address table such as whether the memory referenced by the physical address table is valid or not, whether the memory can be read or read and written to, and if so whether local or remote access is permitted, and the type of memory, i.e. shared, non-shared or memory window.

Protection domain 1720 associates a memory area with a queue protection domain number. Compared to previous implementations, the present invention adds a system image identifier such as SI ID 1 1724 to each record in the protection table 1700 and uses the SI ID 1 1724 to reference a range table, such as range table 1712 which is associated with SI ID 1.

Key instance 1728 provides information on the current instance of the key. Window reference count 1732 provides information as to how many windows are currently referencing the memory. PAT size 1736 provides information on the size of physical address table 1708.

Page size 1740 provides information on the size of the memory page. Virtual address 1744 provides the virtual address. FBO 1748 provides the first byte offset into the memory region.

Length 1752 provides information on the length of the memory. A memory area is typically specified using a starting address and a length.

PCI bus address table 1708 contains the addresses associated with a memory area, such as a memory region (iwarp) or memory window (InfiniBand), that can be directly accessed by the system image associated with the PCI bus address table. The PCI bus address table 1708, contains one or more physical I/O buffers, and each physical I/O buffer is referenced by a PCI bus address 1758 and length 1762, or if all physical buffers are the same size, by just a physical address 1758. PCI bus address 1758 typically contains a PCI bus address that the adapter will use to access system memory. In the present invention, the LPAR manager will have set the PCI bus address equal to the real address that the system memory controller can use to directly access system memory. Length 1762 contains the length of the allotted LMB, if multi-sized pages are supported.

Logical memory block (LMB) table 1712 contains one or more records, with each record comprising PCI bus address 1766 and length 1770. In the present invention, the LPAR manager sets the PCI bus address 1766 equal to the real memory address used by the system memory controller to access memory and therefore does not require any further translation at the host. Length 1770 contains the length of the LMB.

FIG. 18 is a flowchart illustrating allocating memory for a system image in accordance with an illustrative embodiment of the present invention.

Typically, the allocation is performed when the system image is (a) initially booted or (b) reconfigured with additional resources. Typically, a trusted entity such as the Hypervisor or LPAR manager does the allocation.

The operation begins in 1802 when the trusted entity receives a request to allocate memory for the system image. In 1804, for each I/O adapter that has a range table, the trusted entity, such as an LPAR manager or Hypervisor, allocates a set of IB or iWARP style memory region or memory window entries, such as a set of Protection Table 1700 and PCI Bus Address Table 1708 records, for the System Image to use. The trusted entity, such as an LPAR manager or Hypervisor, also loads into each Protection Table 1700 record the System Image ID field, such as SI ID 1 1724, with the identifier of the System Image associated with the entry. The operation then ends.

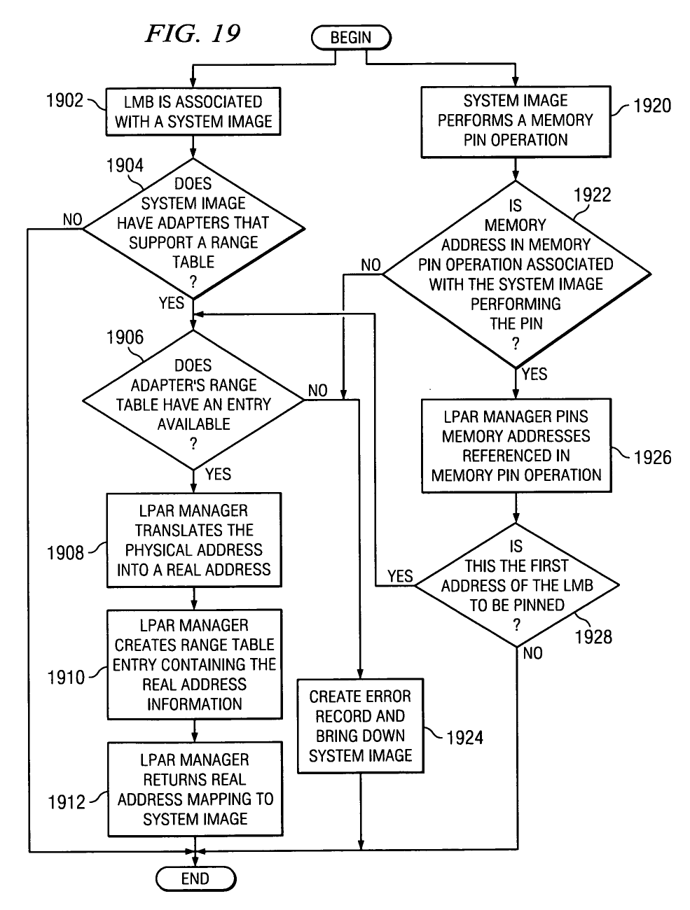

FIG. 19 is a flowchart outlining the functions performed by an LPAR manager, either when a set of memory addresses are associated with a System Image or when a System Image pins a set of memory addresses that it is associated with, to create one or more memory range table entries that are associated with a System Image to a PCI Adapter that supports either the Virtual Adapter or Virtual Resource Management approach in accordance with an illustrative embodiment of the present invention. The LPAR manager can set up a range table entry using either one of these two approaches.

Typically, one or more logical memory blocks (LMB) are associated or disassociated with a system image during a configuration event. A configuration event usually occurs infrequently. In contrast, memory within an LMB is typically pinned or unpinned frequently such that it is common for memory pinning or unpinning to occur millions of times a second on a high end server.

The operation begins in one of two ways. If the LPAR manager sets up range table entries when an LMB is associated with a System Image, then the operation begins when an LMB is associated with a system image in 1902. Next, a determination is made whether the system image has I/O adapters that support range tables in 1904. If the system image does not have I/O adapters that support range tables then the operation ends.

If the system image has I/O adapters that support range tables, then in 1906 the adapter range table is checked to see whether it has an entry available. If the adapter range table has an entry available then in 1908 the LPAR manager translates the physical address into real addresses which equal the PCI bus addresses. The LPAR manager in 1910 then makes an entry in the range table containing the PCI Bus Addresses and length, or the range (high and low) of PCI Bus Addresses. Finally, the LPAR manager returns the PCI bus addresses which equal the real addresses to the system image in 1912 and the operation ends.

If the LPAR manager sets up range table entries when a System Image requests memory to be pinned, then the operation begins when a system image performs a memory pin operation in 1920. In 1922, a check is made to ensure that the memory referenced in the memory pin operation is associated with the system image performing the memory pin. If in 1922 the memory referenced in the memory pin operation is not associated with the system image performing the memory pin then an error record is created in 1924 and the operation ends.

If in 1922 the memory referenced in the memory pin operation is associated with the system image performing the memory pin, then in 1926 the LPAR manager pins the memory addresses referenced in the memory pin operation. Next a check is made in 1928 as to whether this is the first address of the LMB to be pinned. If in 1928 this is not the first address of the LMB to be pinned, then the operation ends successfully, because a pin request had been previously made on an address within the LMB, so the full LMB has already been made available to the adapter's range table for that System Image.

If in 1928 this is the first address of the LMB to be pinned, then in 1906 the adapter range table is checked to see whether it has an entry available. If the adapter range table has an entry available then in 1908 the LPAR manager translates the physical address into real addresses which equal the PCI bus addresses. The LPAR manager in 1910 then makes an entry in the range table containing the PCI Bus Addresses and length, or the range (high and low) of PCI Bus Addresses. Then, the LPAR manager returns the PCI bus addresses which equal the real addresses to the system image in 1912 and the operation ends.

If in 1906 the adapter's range table does not have an entry available, then an error record is created in 1924 and the operation ends.

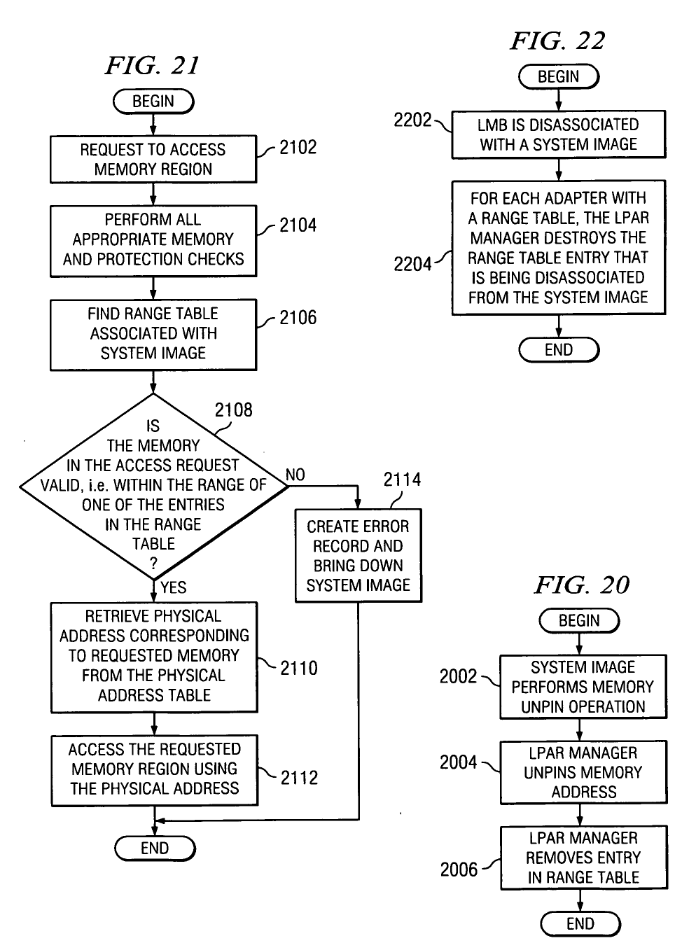

FIG. 20 is a flowchart outlining the functions performed by an LPAR manager, when a System Image unpins a set of memory addresses that it is associated with, to destroy one or more memory range table entries that are associated with a System Image to a PCI Adapter that supports either the Virtual Adapter or Virtual Resource Management approach in accordance with an illustrative embodiment of the present invention. This flowchart is used when the LPAR manager destroys a range table entry at the time the System Image unpins memory.

The operation begins when a System Image performs an unpin operation in 2002. Typically, the unpin operation is performed on the host server by the LPAR manager in order to destroy one or more previously registered memory ranges. The unpin may be an InfiniBand or iWARP (RDMA enabled NIC) unpin.

The LPAR manager unpins, i.e. makes pageable, the real addresses associated with the memory in 2004. The LPAR manager then removes the associated entry for those real addresses in the adapter's range table in 2006. The operation then ends.

FIG. 21 is a flowchart illustrating how accesses to system memory are validated in accordance with an illustrative embodiment of the present invention. Typically, at run-time, a PCI Adapter that supports either the Virtual Adapter or Virtual Resource Management validates accesses to system memory as follows.

The operation begins when the adapter receives a request to access the system image's memory region in 2102. The adapter performs all appropriate memory and protection checks in 2104, such as IB or IWARP memory and protection checks. In 2106 the adapter looks in the Protection table for the Range table associated with the System Image, for example, by using the system image identifier (SI ID). In 2108, the adapter then determines whether the memory region in the access request is valid by determining whether the memory address in the access request is within the range of one of the entries in the adapter's Range table.

If the memory address in the request is within the range of one of the entries in the adapter's Range table then the corresponding physical address is retrieved from the Physical Address table in 2110. In 2112, the requested memory is then accessed using the corresponding physical address, for example, by using the physical address as the PCI bus address.

If the memory address in the request is not within the range of one of the entries in the adapter's Range table, then an error record is created and the system image is brought down in 2114.

FIG. 22 is a flowchart outlining the functions performed by an LPAR manager, when an LMB is disassociated from a System Image that it is associated with, to destroy one or more memory range table entries that are associated with a System Image to a PCI Adapter that supports either the Virtual Adapter or Virtual Resource Management approach in accordance with an illustrative embodiment of the present invention. This flowchart is used when the LPAR manager destroys a range table entry at the time an LMB is disassociated with a System Image.

The operation begins when an LMB is disassociated with a system image in 2202. Then, for each adapter with a range table, the LPAR manager destroys the range table entry associated with the system image in 2204 and the operation ends.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for sharing an input/output adapter among a plurality of operating system instances on a host server, the computer implemented method comprising:
associating a virtual memory with an operating system instance, among the plurality of operating system instances, to form associated memory;
translating the virtual memory to at least one real address, wherein the at least one real address requires no further translation;
exposing the at least one real address to the input/output adapter, wherein the input/output adapter protects access by one operating system instance to the at least one real address associated with another operating system; and
providing the at least one real address to the operating system instance for accessing the associated memory.

2. The computer implemented method of claim 1, wherein the at least one real address is exposed to the input/output adapter as a Peripheral Component. Interconnect Bus Address.

3. The computer implemented method of claim 1, wherein the input/output adapter protects access to the at least one real address using a first data structure containing a set of real address ranges associated with an operating system instance, a second data structure containing a field in each entry that associates an entry to an operating system instance, and a third data structure containing a set of real address associated with the second data structure.

4. The computer implemented method of claim 3, wherein the first data structure is a Range Table, the second data structure is a Protection Table, and the third data structure is a Peripheral Component Interconnect Bus Address Table.

5. The computer implemented method of claim 4, wherein the Range Table is only accessible through a software intermediary, and wherein the software intermediary is one of a Hypervisor or Logical Partitioning manager.

6. The computer implemented method of claim 4, wherein each entry of the Protection Table contains a field that associates the entry to an operating system instance and the field is only accessible through a software intermediary, wherein the software intermediary is one of a Hypervisor or Logical Partitioning manager.

7. The computer implemented method of claim 4, wherein each entry of the Protection Table contains protection controls associated with the entry and fields in the entry, wherein the field in the entry that associates an entry to an operating system instance does not have an associated protection control.

8. The computer implemented method of claim 4, wherein each entry in the Peripheral Component Interconnect Bus Address Table is accessible by one of an operating system instance that registered the entry or a software intermediary, wherein the software intermediary is one of a Hypervisor or Logical Partitioning manager.

9. The computer implemented method of claim 4, wherein the input/output adapter protects access by one operating system instance to the at least one real address associated with another operating system on direct memory address operations by:
using a key to look up a Protection Table;
obtaining an operating system identifier contained in an entry in the Protection Table, wherein the operating system identified defines the Range Table associated with the operating system instance;
obtaining the set of real addresses from the Peripheral Component Interconnect Bus Address Table that is associated to the Protection Table entry;
comparing the set of addresses the operating system instance is attempting to access to the set of real addresses contained in the Peripheral Component Interconnect Bus Address Table and to the set of real addresses contained the Range Table;
performing the operation if the set of real addresses the operating system instance is attempting to access are within the range of both the set of real addresses contained in the Peripheral Component Interconnect Bus Address Table and the set of real addresses contained in the Range Table; and
generating an error and not performing the operation if the set of real addresses the operating system instance is attempting to access are outside the range of either the set of addresses contained in the Peripheral Component Interconnect Bus Address Table or the set of addresses contained in the Range Table.

10. The computer implemented method of claim 1, wherein providing the at least one real address to the operating system instance for enabling adapter access to the associated memory is performed when the operating system instance is initialized.

11. The computer implemented method of claim 1, wherein providing the at least one real address to the operating system instance for enabling adapter access to the associated memory is performed when the system image performs a memory pin operation.

12. The computer implemented method of claim 3, wherein the first data structure is contained in the input/output adapter.

13. The computer implemented method of claim 3, wherein the first data structure is contained in system memory and made accessible to the input/output adapter.

14. The computer implemented method of claim 1, wherein the input/output adapter is one of a physical adapter or a virtual adapter.

15. A data processing system for sharing an input/output adapter among a plurality of operating system instances on a host server, the data processing system comprising:
a bus;
a storage device connected to the bus, wherein the storage device contains computer usable code;
at least one managed device connected to the bus;
a communications unit connected to the bus; and a processing unit connected to the bus, wherein the processing unit executes the computer usable code to associate a virtual memory with an operating system instance, among the plurality of operating system instances, to form associated memory, translate the virtual memory to at least one real address, wherein the at least one real address requires no further translation, expose the at least one real address to the input/output adapter, wherein the input/output adapter protects access by one operating system instance to the at least one real address associated with another operating system, and provide the at least one real address to the operating system instance for accessing the associated memory.

16. The data processing system of claim 15, wherein the input/output adapter protects access to the at least one real address using a first data structure containing a set of real address ranges associated with an operating system instance, a second data structure containing a field in each entry that associates an entry to an operating system instance, and a third data structure containing a set of real address associated with the second data structure.

17. The data processing system of claim 16, wherein the first data structure is a Range Table, the second data structure is a Protection Table, and the third data structure is a Peripheral Component Interconnect Bus Address Table.

18. A computer program product for sharing an input/output adapter among a plurality of operating system instances on a host server, the computer program product comprising:
a computer usable medium having computer usable program code tangibly embodied thereon, the computer usable program code comprising:
computer usable program code for associating a virtual memory with an operating system instance, among the plurality of operating system instances, to form associated memory;
computer usable program code for translating the virtual memory to at least one real address, wherein the at least one real address requires no further translation;
computer usable program code for exposing the at least one real address to the input/output adapter, wherein the input/output adapter protects access by one operating system instance to the at least one real address associated with another operating system; and
computer usable program code for providing the at least one real address to the operating system instance for accessing the associated memory.

19. The computer program product of claim 18, wherein the input/output adapter protects access to the at least one real address using a first data structure containing a set of real address ranges associated with an operating system instance, a second data structure containing a field in each entry that associates an entry to an operating system instance, and a third data structure containing a set of real address associated with the second data structure.

20. The computer program product of claim 19, wherein the first data structure is a Range Table, the second data structure is a Protection Table, and the third data structure is a Peripheral Component Interconnect Bus Address Table.
